(19) United States
(12) Patent Application Publication
(10) Pub. No.: US 2004/0140711 A1
(43) Pub. Date: Jul. 22, 2004

(54) Brake engagement placing a vehicle with an automatic transmission into neutral gear

(76) Inventor: Anthony Louis Romeo, Forks, WA (US)

Correspondence Address: ANTHONY L. ROMEO, 2781 QUILLAYUTE RD., FORKS, WA, 98331, US

(21) Appl. No.: 10/346,491

(22) Filed: Jan. 21, 2003

(51) Int. Cl. B60T 13/66

(52) U.S. Cl. 303/20

(57) ABSTRACT

This invention provides for an automatic transmission vehicle to be placed in neutral gear upon engagement of the brake pedal and to remain in neutral until the brake is released. As soon as the brake is released, the transmission will re-engage the engine into drive or the appropriate gear setting. Certain controls can determine a pre-set cutoff speed, and/or a pre-set RPM setting, and/or a predetermined gear setting when the transmission will not be placed into neutral following engagement of the brake pedal. Controls may be set to override these limits, if braking duration exceeds a certain amount of time or causes a pre-determined decrease in speed or causes a decrease in RPMs. This invention improves mileage on an automatic transmission vehicle by saving the engine from unnecessary friction with the transmission during braking, particularly when the vehicle is coming to a stop or at a stop.

### BACKGROUND OF THE INVENTION

The invention pertains to automatic transmission motor vehicles. The main purpose of the invention is to increase the fuel efficiency by saving the engine the additional friction of the transmission while the vehicle is braking. As of now, automatic transmissions do not go into neutral as the brake is engaged. Instead the transmission stays connected to the engine. In some newer vehicles the transmission will decrease to the same RPM setting as neutral, but the difference is that the transmission is still engaged with the engine . This means that the engine is continuing to supply power to the transmission even though the vehicle is decelerating and not in need of being powered. This also means that when the vehicle is stopped the driver is continuing to depress the brake pedal. The additional friction of the engine on the transmission is unnecessary as the vehicle does not need any additional power as the vehicle is decelerating or is at a stop. When a car normally decelerates from 50 to 45 mph for example, the drop in RPM is approximately 250. The invention will instead send the transmission into neutral and run the engine at the designated idle power setting and disconnect the engine from the transmission so that the load of the engine, however minimal it may be, will not be carried by the transmission.

At lower speeds the system will be the most effective. Not only will the changing from a low gear to neutral and back into the low gear not be as hard on the engine, but the car is already running at below optimal efficiency. This means that a car traveling 20 mph over a constant distance will use more gas than another vehicle traveling 50 mph the same distance with all else kept constant. Since slower moving vehicles use more gas, and the shifting into neutral during low speeds is easier on the moving parts, this system is most effective at slow speeds. At high speeds braking is less frequent and usually for shorter durations of time (unless the car is decelerating to a full stop). These short “spurts” in which the engine would be placed into neutral may not serve as much of an advantage and would be harder on both the transmission and engine when running at high RPMs. The consequence of this is that transmission controls can be set at either a certain RPM, or certain gear setting, or speed at which the transmission will not be shifted into neutral upon engagement of the brake. (No controls can be set as well.) A combination of these elements may be used to set the limits. For example, the transmission could have a predetermined speed of 31 mph in which any braking at or below this speed would place the transmission into neutral and any braking above 31 mph would not all affect the transmission. Using the same example, this would also mean that braking at 36 mph that continued through 31 mph to 26 mph would cause the transmission to go into neutral once the speed dipped below 31 mph and to remain in neutral until the user released the brake at 26 mph. Since city driving involves a lot of starting and stopping at low speeds this would save the engine a small amount of gas each time the vehicle came to a full stop and while the car remaining stopped and still running. Since automatic transmissions are preferred over standard transmissions for city driving, this would make this invention even more advantageous.

Using the invention, controls could also be set that would disconnect the engine from the transmission at high speeds if the brake had been engaged for a certain amount of time or a set amount of deceleration in speed or decrease in RPM had occurred due to braking; even if a pre-set limit had prevented the transmission from going into neutral. For example, if the transmission cut-off speed for using this system was 26 mph, the transmission could still be placed into neutral at 55 mph upon sensing that the user had decelerated for a period of 3 seconds or more—with 3 seconds chosen as the amount of time necessary before disengaging the transmission from the engine. This use of time as a measure of determining whether to engage the system would show that the user is intending to slow the vehicle dramatically or stop the vehicle altogether. In this case, a vehicle that is slowing down from say 75 to 0, to check a flat tire for example, would save fuel by having the car engine in idle after a certain pre-set amount of braking had occurred. Since no power is needed in coming to a complete stop all power used by the engine to run the transmission is unnecessary. The same control could be used by choosing a drop in 350 RPM due to braking as an indication that the vehicle is slowing dramatically or coming to a full stop. Finally, a drop in speed due to braking, a decrease in 8 mph for example, could be used as an indicator in placing the transmission into neutral.

The effect on the user of a vehicle with this system in place would be minimal to none. Most users would probably not notice that the transmission had disengaged from the engine upon brake use. Since the user would never be pressing both the brake and the acceleration pedal at the same time, the system would never counteract the inputs of the users.

### SUMMARY OF THE INVENTION

Applicant's invention is a system of placing an automatic transmission engine into neutral upon engagement of the brake pedal by the user and for the duration of use of the brake pedal. Upon releasing the brake pedal the transmission will return the vehicle to drive or the appropriate gear setting. The invention will include using the brake sensor to send an input to the transmission controls upon engagement of the brake. The invention will involve programing the transmission control module to actuate release of the transmission from the engine upon receiving the signal from the brake sensor indicating that the brake is being used. Once the brake is released the invention will involve programming the transmission control module to return the transmission into drive or the appropriate gear setting. A system of controlling the transmission from being placed into neutral during braking can be programmed for circumstances when the invention will not be used. At a certain speed, gear setting, or RPM or a combination of the three, the transmission control module would designate that the transmission will remain in drive rather than go into neutral. Another system of controls would establish circumstances in which the transmission would go into neutral and for the remainder of brake use even if pre-set controls were established. This would mean that if braking occurred for a long enough period of time or if a certain decrease in speed occurred due to braking or a decrease in RPMs resulted from braking, then this would override any pre-set speed, gear setting, or RPM limit controls at which the transmission would not be placed in neutral upon engagement of the brake. As an example, if a pre-set control of 31 mph was set in which braking above this speed would not affect the transmission, then all braking above this speed would not affect the transmission unless the braking dropped below the speed of 31 mph. If with the same example, a braking time of 3 seconds was established at which the transmission would be placed into neutral this would override any pre-set speed, gear setting, or RPM limit controls preventing the transmission from going into neutral.

The system is particularly useful for automatic transmissions used in the city or used frequently at low speeds in which the vehicle is slowing down often. Each time the brake is pressed, the mileage of the vehicle would be increased due to the unnecessary friction of the transmission on the engine that would be saved. However minimal, the benefits are best seen in city driving. An easy example of how gas would be conserved is when an automatic transmission vehicle is running but at a complete stop. The engine is providing power to the transmission to move the vehicle forward even though the vehicle is at a complete stop. This energy used by the engine is unnecessary.

Since the invention requires not much more than a few additional wires and associated parts and reprogramming of the transmission, existing vehicles will be able to install the invention with little labor and costs. Automatic transmission vehicle manufacturers will also be able to add the invention to future cars with even less labor required than would be required to update present vehicles.

### BRIEF DESCRIPTION OF THIE DRAWINGS

No drawings were included with application.

### DETAILED DESCRIPTION OF THE INVENTION

In the absence of the present invention, the transmission would remain in gear during the engagement of the brake. The preferred method of deriving a signal from engagement of the brake to the transmission, if the particular vehicle did not already have a sensor for this, would be through the use of the brake lights. This sensor is already setup to detect brake use immediately upon engagement of the brake. The linkage from the brake light would be a branching wire that would connect to the transmission control module where the transmission would be programmed to execute placement of the transmission into neutral upon receiving input from the brake. Pre-set controls in the transmission control module could be used to prevent this by determining that the vehicle speed was too high or the gear setting was too high or the RPMs were too high, or a combination thereof. The transmission control module could be programmed to override these pre-set controls if certain situations occurred which could include a certain amount of drop in vehicle speed due to braking, decrease in RPMs due to braking, or a set duration of braking occurred. If one of these said conditions were met the transmission would be placed into neutral for the duration of the braking. The transmission control module would need to be reprogrammed with the desired settings of the manufacturer. This would allow current vehicles to be set up with the invention with little work and allow auto makers to install the system with a relatively small amount of labor.

I claim:

I brake pedal which when depressed, will send an input signal to the transmission control module and place the transmission into neutral until another input signal from the brake is sent to the transmission control module signaling that the brake has been released;

III input from brake can be sent, from a branch on the brake light indicator to the transmission if there is currently no sensor connecting the transmission and the brakes;

IV pre-set controls in the transmission control module can be set to determine a certain cut-off speed, or RPM setting, or predetermined gear setting, or combination thereof, at which when the vehicle is above will not allow the transmission to disengage from the engine when the brake is engaged;

VI when said brake pedal is engaged with activated said pre-set controls and the vehicle is in the zone whereas the transmission will not be shifted into neutral, the transmission will remain in gear until the point that the said pre-set limit has been reached;

VII once the said pre-set limit is surpassed the transmission control module will disengage transmission from the engine for the remainder of the braking;

VII if said pre-set controls are used, and the vehicle is above said pre-set controls, the transmission control module may still place the transmission into neutral for the duration of the braking if the brake has been engaged for a certain amount of time or a set amount of deceleration in speed has been detected due to braking or a certain decrease in RPMs due to braking had occurred (or combination)

VIII braking disengagement of the transmission would also work in reverse, as well as in all forward drive gears.
